(19) United States
(12) Patent Application Publication
(10) Pub. No.: US 2016/0105552 A1
(43) Pub. Date: Apr. 14, 2016

(54) INTELLIGENT ROUTING FOR FIXED MOBILE CONVERGENCE SYSTEM

(71) Applicant: AXIOM IT SOLUTIONS PTE. LTD., Singapore (SG)

(72) Inventors: Pang Ngean LAM, Singapore (SG); Khoon Yong Chua, Singapore (SG); Teck Khiam Lam, Singapore (SG)

(73) Assignee: AXIOM IT SOLUTIONS PTE. LTD., Singapore (SG)

(21) Appl. No.: 14/879,268

(22) Filed: Oct. 9, 2015

(30) Foreign Application Priority Data
Oct. 9, 2014 (SG) 10201406473T

(51) Int. Cl. H04M 3/42; H04M 3/54

(52) U.S. Cl. CPC H04M 3/42348; H04M 3/42153; H04M 3/42263; H04M 3/543

(57) ABSTRACT

A system and method for fixed mobile convergence for transferring a call directed to a first phone of a user to one of another set of phones is disclosed. The method comprises monitoring a position of a mobile phone, establishing a zone around the mobile phone which changes as the position of the mobile phone changes, identifying a closest phone as one of the another set of phones with a location closest to the position of the mobile phone and within the zone at a time of the call, and routing the call to the closest phone. The system uses a cloud computer operatively connected to both the mobile phone, the first phone and the another set of phones and monitors the position of the mobile phone.

This application claims priority benefit of Singapore Patent Application No. 10201406473T, filed on 9 Oct. 2014.

### FIELD OF THE INVENTION

This invention relates to fixed mobile convergence systems, and more particularly to intelligent routing for fixed mobile convergence systems operable over a wide area.

### BACKGROUND OF THE INVENTION

Fixed mobile convergence (FMC) refers to the ability of telecommunications companies to provide their subscribers with services that interact with and use both the fixed networks of incumbent wireline and/or cable operators (as well as the wife internet which is accessible via the same wireline) and the mobile/cellular networks of mobile operators. The two systems have grown up independently of each other and they work in different ways and are priced differently. Generally fixed networks are cheaper than cellular networks. Fixed Mobile Convergence systems are one of the hottest topics for telecommunications companies and enterprise communications today. Fixed line business is deteriorating, and major telecommunications companies are exploring ways to create new products with fixed mobile convergence technology.

Known FMC technologies rely on a Wi-Fi hotspot. That is, once a phone is detected by the Wi-Fi network, a call directed to the mobile phone may be routed to a fixed position/landline phone. However, such known technologies are inherently limited by the short range of the Wi-Fi hotspot. It would be desirable to provide a method and system for fixed mobile convergence which allows a user of a phone to operate over an area much larger than that of a Wi-Fi network.

### SUMMARY OF THE INVENTION

In accordance with a first aspect, a system and method for fixed mobile convergence for transferring a call directed to a first phone of a user to one of another set of phones is disclosed. The method comprises monitoring a position of a mobile phone, establishing a zone around the mobile phone which changes as the position of the mobile phone changes, identifying a closest phone as one of the another set of phones with a location closest to the position of the mobile phone and within the zone at a time of the call, and routing the call to the closest phone. The system uses a cloud computer operatively connected to both the mobile phone, the first phone and the another set of phones and monitors the position of the mobile phone.

From the foregoing disclosure and the following more detailed description of various embodiments it will be apparent to those skilled in the art that the present invention provides a significant advance in the technology of fixed mobile convergence systems. Particularly significant in this regard is the potential the invention affords for providing a fixed mobile convergence system adapted for users who travel between offices. Additional features and advantages of various embodiments will be better understood in view of the detailed description provided below.

### BRIEF DESCRIPTION OF THE DRAWINGS

FIG. 1 shows a schematic of a fixed mobile convergence system and method in accordance with one embodiment.

FIG. 2 shows an example of a screen shot for an application used on a mobile phone in accordance with the fixed mobile convergence system of FIG. 1

FIG. 3 shows another screen shot for the application of FIG. 2, showing the ability of the user to adjust a zone around the mobile phone.

FIG. 4 shows another screen shot for the application of FIG. 2 where a user may input and/or select phone locations.

FIG. 5 shows another screen shot for indicating a new location for a phone.

It should be understood that the appended drawings are not necessarily to scale, presenting a somewhat simplified representation of various features illustrative of the basic principles of the invention. The specific design features of the fixed mobile convergence system as disclosed here, including, for example, the specific zone from with which a phone may be selected, will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the fixed mobile convergence system disclosed here. The following detailed discussion of various alternate features and embodiments will illustrate the general principles of the invention with reference to a fixed mobile convergence system especially suitable for use with a user who travels between offices. Other embodiments suitable for other applications will be apparent to those skilled in the art given the benefit of this disclosure.

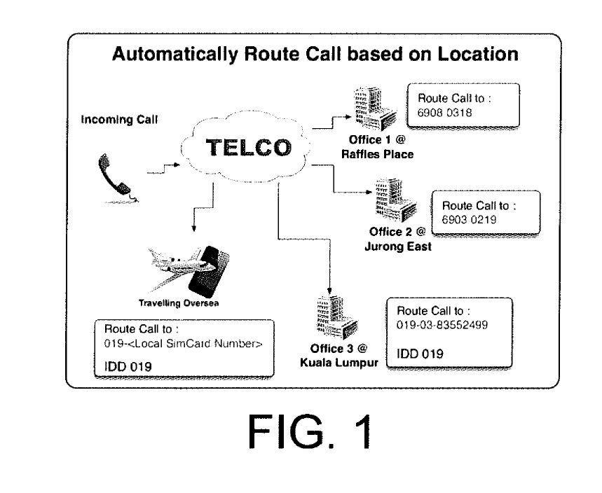

Turning now to the drawings, FIG. 1 shows an intelligent routing for fixed mobile convergence system having fixed phones/landlines, mobile phones/handphones and phones which generate incoming calls directed to a particular mobile phone. A first phone can be, for example, an office landline (shown underneath the words “Incoming Call”). Another set of phones (Office 1, 2, 3 in FIG. 1) can comprise any phones (generally other fixed phones, but also can comprise mobile phones) receives a forwarded call if certain criteria are met, as disclosed below. A cloud computer is shown schematically and labeled Telco. The cloud computer is a computer operatively connected to the other elements of the system which may or may not be in a remote location. Some of the software of the system, may be stored at the cloud computer. Mobile phones are understood herein to include any device which allows users to speak to one another such as smartphones and tablets, for example.

The cloud based fixed mobile convergence system disclosed herein enables users to manage their IP centrex services (that is, services where the call platform and private branch exchange features are hosted at the service provider location) and Enterprise IPPBX (that is, private branch exchange or telephone switching system within an enterprise that switches calls between VoIP (voice over Internet Protocol or IP) users on local lines while allowing all users to share a certain number of external phone lines) using smart phones and tablets.

Generally it is preferable to route calls initially directed to a fixed phone to another fixed phone, since the rates are typically less. In accordance with a highly advantageous feature, the mobile phone controls which of another set of phones the incoming call is routed to. More specifically, calls are routed based on a position of the mobile phone. The system can identify the position of the mobile phone by having the cloud computer operatively connected to a global positioning system (GPS) formed as part of the mobile phone, for example. The first phone and the another set of phones can have locations which are known to the cloud computer of the system. The system identifies a closest phone by determining which phone is closest to the position of the mobile phone at the time of the incoming call and routes that call to that closest phone. A zone may be established around the mobile phone and the system may search for one of the another set of phones only in that zone at a time of the call. In the representative example of FIG. 1, an incoming call to a landline of a user who is traveling may be transferred or routed to a landline at another office in Raffles Place, Singapore when Raffles Place is in the zone around the mobile phone (that is, the user is at or near the Raffles Place office). In a similar manner, the call may be routed to a landline at an office in Jurong East, Singapore when Jurong East is in the zone around the mobile phone, and the call may be routed to a landline at an office in Kuala Lumpur, Malaysia when Kuala Lumpur is in the zone around the mobile phone. Generally the zone around the mobile phone changes as the position of the mobile phone (and the corresponding user) changes. Routing calls in this manner helps frequent business travelers to save on roaming charges, and services providers to keep the traffic within their network.

In accordance with another advantageous feature, some of the elements of the system may be stored in the cloud. That is, not all of the data needs to be stored on the mobile phones. Rather, the mobile phone need merely be operably connected to the cloud computer to access data. Data can comprise, for example, storing of locations of fixed phones. Building the system in the cloud advantageously lowers initial deployment costs, makes the system highly scalable, and allows flexibility to offer different business models suiting different customers' needs.

The system disclosed herein advantageously enables control of Hosted IP-Centrex (Virtual PBX), and On-premises IP-PBX, using the mobile device. The control includes the creation and management of individual users profiles, call treatment, routing logic, fixed line missed call notification on mobile device, features activations, voice recording, time scheduling, and calling plans. Other elements suitable for use in the system disclosed herein will be readily apparent to those skilled in the art given the benefit of this disclosure.

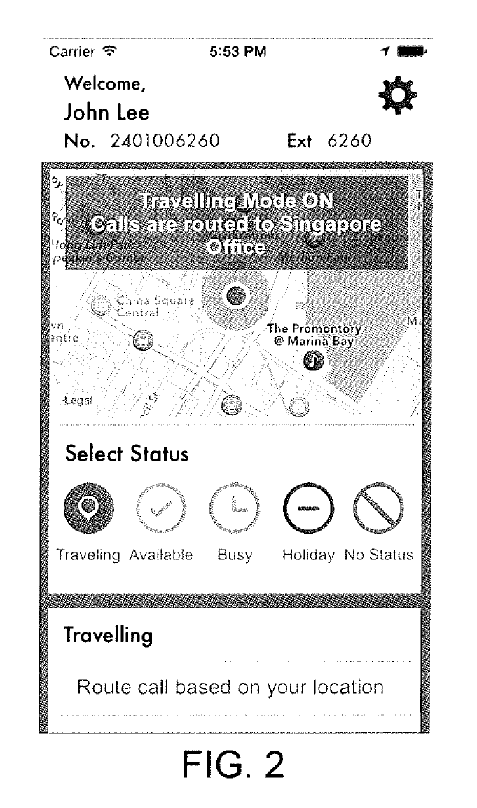

Typically the position of the mobile phone is known by (the cloud computer) accessing the global positioning system, part of which is on the mobile phone. An application (app) can be downloaded to the mobile phone to allow for interconnection between the cloud computer, the mobile phone, the first phone and the another set of phones, as well as to allow the user of the mobile phone to input data about himself, about his preferred zone, and about fixed phones he may wish to access. FIG. 2 shows a representative example of a screen shot for an application used on a mobile phone in accordance with the fixed mobile convergence system disclosed herein. The zone may be set by the user using the app, and data about the locations of phones may be input by the user. The app can allow the user to toggle between a traveling mode (as shown in FIG. 2) where the call can be routed to the closest phone, and an off mode where the call is directed to the first phone. Optionally if the closest phone is busy and another phone is located in the zone, then the system may route the call to another phone in the another set of phones in the zone.

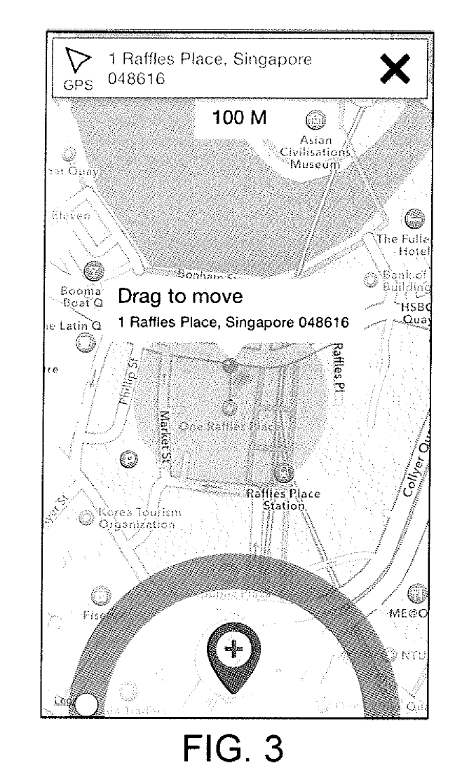

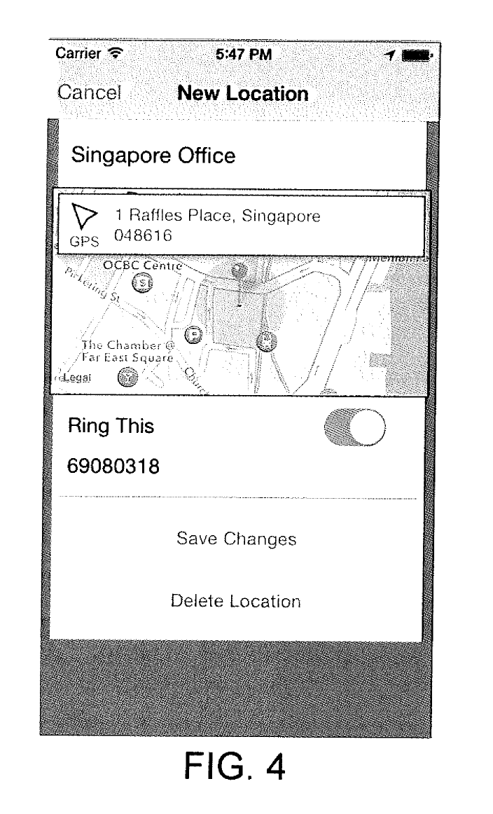

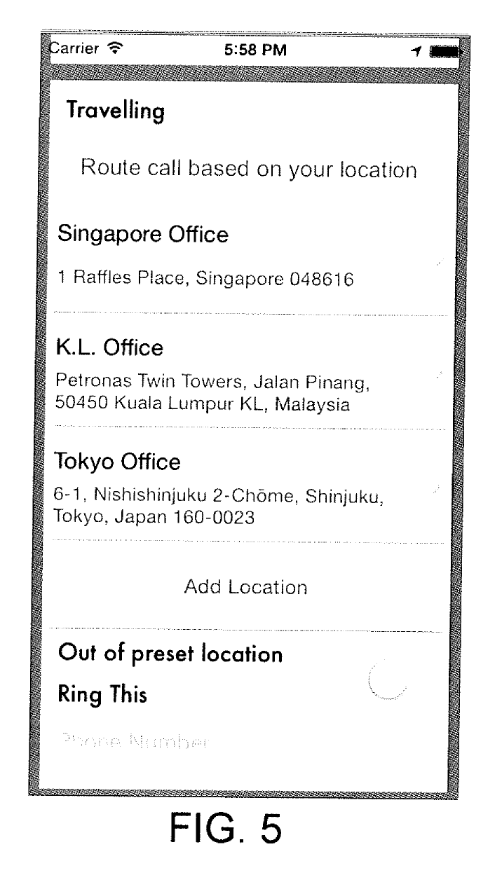

FIG. 3 shows a representative screen shot of the app on the mobile phone displaying a map corresponding to the location of the user. Optionally the user may adjust the size of the zone surrounding his mobile phone using a drag to move command. FIGS. 4 and 5 shows a screenshot for providing a list of locations, adding a location (of a landline), and showing a new location. The app also provides the user with the option to route the call to a number of the user's choice when the mobile phone is outside of a zone/preset location. Other types of beneficial information which may be presented on display screens of the users will be readily apparent to those skilled in the art given the benefit of this disclosure.

Advantageously the system may be operatively connected to other networks, other computers and other systems. For example, the application may screen a call and determine whether the call passes predetermined screening criteria, and only those calls that pass such criteria are permitted to be routed to the closest phone. Such call screening features may be operatively connected with an external database such as a ‘Do-Not-Call’ database. As another example, the system may be operatively connected to social network websites (for example Facebook, Twitter, Linkedin, etc.). Such connections may be advantageous to the user. For example, the application can operatively connect the mobile phone to the social networking website, and a marketing event can be created on the social networking website. Contact information about individuals who indicate interest about the marketing event can be collected by the system (and stored on the cloud computer, for example), and the collected contact information made available to the user of the mobile phone.

The following features may be part of the fixed mobile convergence system disclosed herein: mobile phone based intelligent control and routing; mobile phone location based tracking and routing; IP-Centrex Gateway control; IP-PBX Gateway control; user registration, provisioning, and other related user data; accounting and billing; a gateway to social networking websites; called number screening with access to an external database (for example, Personal Data Protection Act-PDPA databases); SIP trunking (which is a Voice over Internet Protocol (VoIP) and streaming media service based on the Session Initiation Protocol (SIP) by which Internet telephony service providers (ITSPs) deliver telephone services and unified communications to customers equipped with SIP-based private branch exchange (IP-PBX) and Unified Communications facilities) management; as well as interfacing with mobile applications on iOS, Android, and Windows for smartphones and tablets. The cloud fixed mobile convergence system disclosed herein also advantageously is adapted to work with various industry leading PBXs systems, and link multiple vendors together into a single system which enables ‘seamless roaming’ by the users of the system.

The routing system disclosed herein can achieve productivity and cost savings for the enterprise customer. For example, consider a businessman who travels frequently around various offices. Without the system, he will not be able to answer his incoming calls to his office fixed lines if he is not at his desk, he will need to pay for expensive roaming charges when someone call his mobile phone when he is overseas. With the system, he can set his profile anytime, anywhere on his mobile device. The cloud fixed mobile convergence system is able to detect his location based on his mobile device. Based on his profile setting using the app on his mobile device and his location, the cloud system is able to route his incoming call to his office or to his other office phone lines. With an appropriate profile setting on the application of the system, he can also save on roaming charges for incoming calls to his mobile phone.

The system disclosed herein is useful for telecommunications companies. However, the system is highly scalable and expandable and can be extended to other industries including, for example the logistics/transport sector by integrating industry specific work flows, location based tracking, messaging and voice communications.

From the foregoing disclosure and detailed description of certain embodiments, it will be apparent that various modifications, additions and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for fixed mobile convergence for transferring a call directed to a first phone of a user to one of another set of phones, comprising, in combination, the steps of:
monitoring a position of a mobile phone;
establishing a zone around the mobile phone which changes as the position of the mobile phone changes;
identifying a closest phone as one of the another set of phones with a location closest to the position of the mobile phone and within the zone at a time of the call; and
routing the call to the closest phone.

2. The method of claim 1 wherein the position of the mobile phone is known using a global positioning system on the mobile phone.

3. The method of claim 1 wherein the zone is set by the user of the mobile phone.

4. The method of claim 1 further comprising the step of setting the locations of the another set of phones by the user.

5. The method of claim 1 further comprising the step of:
screening the call, wherein calls which pass predetermined criteria are permitted to be routed to the closest phone.

6. The method of claim 1 further comprising the step of:
routing the call to another phone in the zone when the closest phone is busy.

7. The method of claim 1 further comprising the step of:
downloading an application onto the mobile phone, wherein the application allows the user to toggle between a traveling mode where the call can be routed to the closest phone, and an off mode where the call is directed to the first phone.

8. The method of claim 1 further comprising the steps of:
creating a marketing event on a social networking website;
collecting contact information about individuals who indicate interest about the marketing event; and
connecting the mobile phone to the social networking website, making the collected contact information available to the user of the mobile phone.

9. A fixed mobile convergence system for transferring a call directed to a first phone of a user to one of another set of phones comprising, in combination:
a cloud computer operatively connected to both the mobile phone, the first phone and the another set of phones, wherein the cloud computer monitors a position of the mobile phone;
wherein the mobile phone has a zone around the mobile phone which changes as the position of the mobile phone changes; and
the cloud computer identifies a closest phone as the one of the another set of phones with a location closest to the position of the mobile phone and within the zone at a time of the call, and routes the call to the closest phone.

10. The fixed mobile convergence system of claim 9 wherein the position of the mobile phone is known using a global positioning system operatively connected with the mobile phone.

11. The fixed mobile convergence system of claim 10 further comprising an application on the mobile phone, wherein the application allows the user to toggle between a traveling mode where the call can be routed to the closest phone, and an off mode where the call is directed to the first phone.

12. The fixed mobile convergence system of claim 10 wherein the zone is set by the user of the mobile phone.

13. The fixed mobile convergence system of claim 10 wherein the locations of the another set of phones are set and stored by the user.

14. The fixed mobile convergence system of claim 10 wherein the application screens the call, wherein calls which pass predetermined criteria are permitted to be routed to the closest phone.

15. The fixed mobile convergence system of claim 10 wherein the application routes the call to another phone in the zone when the closest phone is busy.

16. The fixed mobile convergence of claim 10 wherein the application operatively connects the mobile phone to a social networking website, wherein a marketing event is created on the social networking website and contact information about individuals who indicate interest about the marketing event is collected, and the collected contact information available to the user of the mobile phone.
